(19) United States
(12) Patent Application Publication
(10) Pub. No.: US 2011/0248174 A1
(43) Pub. Date: Oct. 13, 2011

(54) Collimator for Low-Dose Molecular Breast Imaging

(76) Inventors: Michael K. O'Connor, Rochester, MN (US); Carrie B. Hruska, Mantorville, MN (US); Amanda L. Weinmann, Rochester, MN (US)

(21) Appl. No.: 13/131,661

(22) PCT Filed: Dec. 8, 2009
(86) PCT No.: PCT/US2009/067084

§ 371 Date: May 27, 2011

Related U.S. Application Data
(60) Provisional application No. 61/121,108, filed on Dec. 9, 2008.

(51) Int. Cl. G21K 1/02

(52) U.S. Cl. 250/363.1

(57) ABSTRACT

A system and method for nuclear imaging includes a molecular breast imaging system including a collimator coupled to each of at least two gamma cameras. The collimator includes a collimator plate composed of a radiation absorbing material and having formed therein a plurality of channels spaced in an arrayed arrangement, each of the plurality of channels extending from an upper surface of the collimator plate to a lower surface of the collimator plate along a distance configured to substantially maximize a geometric efficiency of the collimator for a selected septal penetration, source-to-collimator distance, and collimator material. The collimator also includes a plurality of septa formed between each adjacent ones of the plurality of channels and the plurality of detector elements and the plurality of channels have a substantially similar cross-sectional shape.

### CROSS-REFERENCE TO RELATED APPLICATIONS

This application claims the benefit of U.S. Provisional Patent Application Ser. No. 61/121,108, filed on Dec. 9, 2008, and entitled “Collimator Optimization for Low-Dose Molecular Breast Imaging.”

### BACKGROUND OF THE INVENTION

The field of the invention is imaging systems and methods. More particularly, the invention relates to systems and methods for providing desirable collimation for a pixelated dual-head gamma camera system designated for molecular breast imaging.

Screening mammography has been the gold standard for breast cancer detection for over 30 years, and is the only available screening method proven to reduce breast cancer mortality. However, the sensitivity of screening mammography varies considerably. The most important factor in the failure of mammography to detect breast cancer is radiographic breast density. In studies examining the sensitivity of mammography as a function of breast density, it has been determined that the sensitivity of mammography falls from 87-97 percent in women with fatty breasts to 48-63 percent in women with extremely dense breasts.

Diagnostic alternatives to mammography include ultrasound and magnetic resonance imaging (“MRI”). The effectiveness of whole-breast ultrasound as a screening technique does not appear to be significantly different from mammography. MRI has a high sensitivity for the detection for breast cancer and is not affected by breast density. However, since bilateral breast MRI is currently approximately 20 times more expensive than mammography, it is not in widespread use as a screening technique.

Another prior-art technology is positron emission mammography (“PEM”). This uses two, small, opposing positron emission tomography (“PET”) detectors to image the breast. The PEM technology offers excellent resolution; however, the currently available radiopharmaceutical, F-18 fluorodeoxyglucose (“F18-FDG”), requires that a patient fast overnight, the patient must have low blood levels (this is often a problem for diabetics), and after injection, the patient must wait 1-2 hours for optimum uptake of F18-FDG in the tumor. The high cost of these PET procedures coupled with the long patient preparation time reduces the usefulness of this procedure and makes it difficult to employ for routine breast evaluation.

Radionuclide imaging of the breast (“scintimammography”) with the radiopharmaceutical agent Tc-99m (metastable nuclear isomer of technetium-99) sestamibi was developed in the 1990s and has been the subject of considerable investigation over the last 10-15 years. This functional method is not dependent upon breast density. Large multi-center studies have shown the sensitivity and specificity of scintimammography in the detection of malignant breast tumors to be approximately 85 percent. However, these results only hold for large tumors and several studies have shown that the sensitivity falls significantly with tumor size. The reported sensitivity for lesions less than 10-15 mm in size was approximately 50 percent. This limitation is particularly important in light of the finding that up to a third of breast cancers detected by screening mammography are smaller than 10 mm. Prognosis depends on early detection of the primary tumor. Spread of a cancer beyond the primary site occurs in approximately 20-30 percent of tumors 15 mm or less in size. However, as tumor size grows beyond 15 mm, there is an increasing incidence of node positive disease, with approximately 40 percent of patients having positive nodes for breast tumors 2 cm in diameter. Hence, for a nuclear medicine technique to be of value in the primary diagnosis of breast cancer, it must be able to reliably detect tumors that are less than 15 mm in diameter. The failure of conventional scintimammography to meet this limit led to its abandonment as a useful technique in the United States.

In an attempt to overcome the limitation of conventional scintimammography, several small field-of-view gamma cameras have been developed that permit the breast to be imaged in a similar manner and orientation to conventional mammography. One commercial system for single photon imaging that is currently available is that manufactured by Dilon Technologies of Newport News, Va. Using a small detector and compression paddle, a sensitivity of 67 percent for the detection of sub-10 mm lesions has been reported.

Therefore, various radionuclide imaging techniques utilize radiopharmaceuticals, such as Tc-99m sestamibi or Tc-99m tetrofosmin, to image breast tissue. When administered in small amounts, the radiation receive by the body is low; however, when larger amounts are given, it may cause adverse effects in the body. It would therefore be desirable to provide diagnostic imaging tools and procedures that would reduce the amount of radiation exposed to the patient.

### SUMMARY OF THE INVENTION

The present invention overcomes the aforementioned drawbacks by providing systems and methods for imaging of breast tissue using a gamma camera system that includes a collimator having an aperture scheme that matches the structure of a pixelated detector. The collimator characteristics are selected based on the average thickness of the breast under light compression and are designed to provide improved sensitivity to radioactivity in the breast, while retaining acceptable resolution. This high sensitivity permits the use of a low dose of radioactivity to be administered, thereby reducing the radiation dose to the patient.

It is an aspect of the invention to provide a molecular breast imaging system including a collimator coupled to each of at least two gamma cameras. The collimator includes a collimator plate composed of a radiation absorbing material and having formed therein a plurality of channels spaced in an arrayed arrangement, each of the plurality of channels extending from an upper surface of the collimator plate to a lower surface of the collimator plate along a distance configured to substantially maximize a geometric efficiency of the collimator for a selected septal penetration, source-to-collimator distance, and collimator material. The collimator also includes a plurality of septa formed between each adjacent ones of the plurality of channels and the plurality of detector elements and the plurality of channels have a substantially similar cross-sectional shape.

It is another aspect of the invention to provide a method for manufacturing a collimator for use with a nuclear imaging system including at least two gamma cameras in spaced arrangement such that a region for receiving a portion of a subject is defined therebetween, each gamma camera including a detector comprising a plurality of detector elements arranged in an array. The method includes forming a collimator plate composed of a radiation absorbing material and creating a plurality of channels spaced in an arrayed arrangement. The method also includes forming upper surface of the collimator plate and a lower surface of the collimator plate, the upper surface of the collimator plate and the lower surface of the collimator plate separated by a distance calculated using a relationship of geometric efficiency of the collimator to source-to-collimator distance.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is an illustration of a molecular breast imaging system for use with the present invention;

FIG. 2A is a schematic illustration of an exemplary configuration of a parallel-hole collimator and its corresponding design parameters;

FIG. 2B is a schematic illustration of an exemplary configuration of a parallel-hole collimator showing the relationship between minimum source-to-collimator distance and collimator hole size, collimator channel length, and collimator resolution

FIG. 3A is a schematic illustration of a prior art arrangement of a hexagonal aperture collimator overlaid on a pixelated detector;

FIG. 3B is a schematic illustration of an exemplary square aperture collimator in which each aperture is aligned with a detector element;

FIG. 4A is a schematic illustration of an exemplary configuration of a gamma camera system employing the square aperture collimator shown in FIG. 3B;

FIG. 4B is a schematic illustration of another exemplary configuration of a gamma camera system employing the square aperture collimator shown in FIG. 3B;

FIG. 5 is a graphic illustration of three tumors in a breast undergoing imaging by a dual-head gamma camera system including the collimator of FIG. 3B;

FIGS. 6A and 6B are schematic illustrations of another exemplary configuration of a gamma camera system employing the square aperture collimator shown in FIG. 3B; and

FIG. 7 is a schematic illustration of exemplary adjustable collimator system for use with the MBI system of FIG. 1.

### DETAILED DESCRIPTION OF THE INVENTION

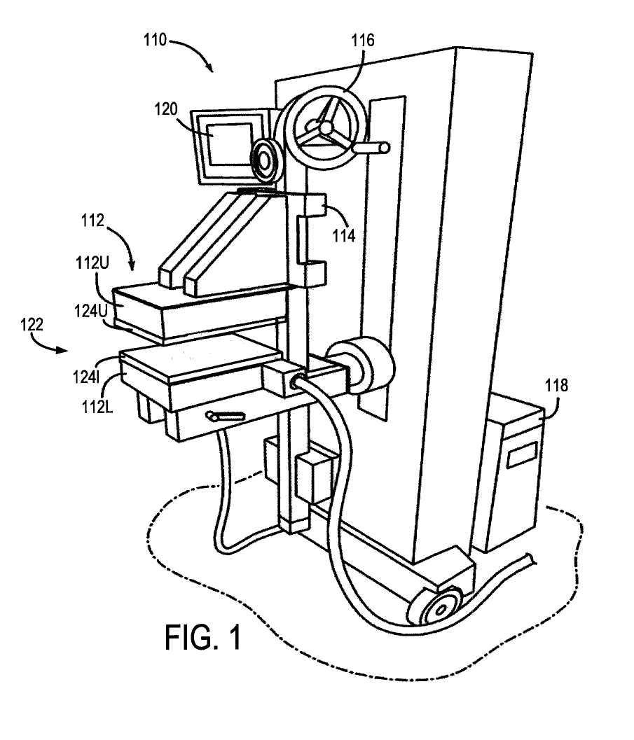

Referring to FIG. 1, a nuclear medicine-based MBI system 110 includes two opposing gamma cameras 112. Exemplary gamma cameras include those having arrayed cadmium zinc telluride (“CZT”) semiconductor detector elements; however, it will be appreciated by those skilled in the art that alternative detectors materials could similarly be employed, such as sodium iodide (“NaI”), thallium-activated sodium iodided (“NaI(Tl)”), bismuth germinate (“BGO”), gadolinium oxyorthosilicate (“GSO”), and lutetium oxyorthosilicate (“LSO”) scintillator crystal detectors. In particular, the opposing gamma cameras 112 include an upper gamma camera 112U and a lower gamma camera 112L. Each gamma camera, 112U and 112L, is, for example, 20 centimeters (“cm”) by 16 cm in size and mounted on a modified upright type mammographic gantry 114. In accordance with one embodiment, the gamma camera 112 are LumaGEM 3200S high-performance, solid-state cameras from Gamma Medica having a detector element size of 1.6 millimeters (“mm”). LumaGEM is a trademark of Gamma Medica, Inc. Corporation of California.

The relative position of the gamma cameras 112 can be adjusted using a user control 116. Specifically, the gamma camera assemblies 112 are, preferably, designed to serve as a compression mechanism. Accordingly, this system configuration reduces the maximum distance between any lesion in the breast and either gamma camera 112 to one-half of the total breast thickness, potentially increasing detection of small lesions without additional imaging time or dose. The MBI system 110 includes a processor 118 for processing the signals acquired by the gamma camera 112 in order to produce an image, which may be displayed on an associated display 120.

During an imaging process, the breast is compressed between the two gamma cameras 112 and collimation detects radiation emitted by single-photon radiopharmaceuticals, such as Tc-99m sestamibi, administered to the subject being imaged. The MBI system 110 has been shown to have a very high sensitivity, for example, greater than 90 percent, for the detection of sub-10 mm lesions. In addition, a large (1000 patient) study has found that MBI using, for example, the MBI system 110, detected 3 times as many cancers as digital and analog mammography in asymptomatic women at increased risk of breast cancer. More recent studies have found the sensitivity of MBI to be comparable to that of MRI. Thus, MBI can be a very attractive alternative to mammography, particularly in women at increased risk of breast cancer and in women with dense breast tissue.

A variety of radiopharmaceuticals have been used for breast imaging, such as imaging with the MBI system 110. One of the most common radiopharmaceutical is Tc-99m sestamibi; however, other Tc-99m labeled pharmaceuticals have found use, such as Tc-99m tetrofosmin. Published studies to date have typically employed administered doses of Tc-99m in the range of around 20-30 millicurie (“mCi”). While the biodistribution of each radiopharmaceutical may differ, the effective radiation dose to the body is similar for most of these radiopharmaceuticals. By way of example, the effective radiation dose of a 20 mCi injection of a Tc-99m labeled radiopharmaceutical is in the range of around 7-10 millisievert (“mSv”). This radiation burden is an order of magnitude larger than that delivered to the patient from a screening mammogram, which imparts an effective radiation dose of around 0.7-1.0 mSv. Therefore, it would be an advantage in the art to development methods and techniques to reduce the administered dose of radiopharmaceutical required to obtain satisfactory images with the MBI for both the diagnosis and screening of breast cancer.

A collimation system is typically used in breast imaging systems, such as the MBI system 110, to protect against bombarding the detector elements with photons that would otherwise produce significant noise in the resulting image. However, the tradeoff of using a collimator to protect against noise is the corresponding reduction in the sensitivity of the gamma camera. As will be described, the present invention includes a collimation system, generally designated 122, including a upper collimator 124U and a lower collimator 124L that are respectively associated with the upper gamma camera 112U and the lower gamma camera 112L.

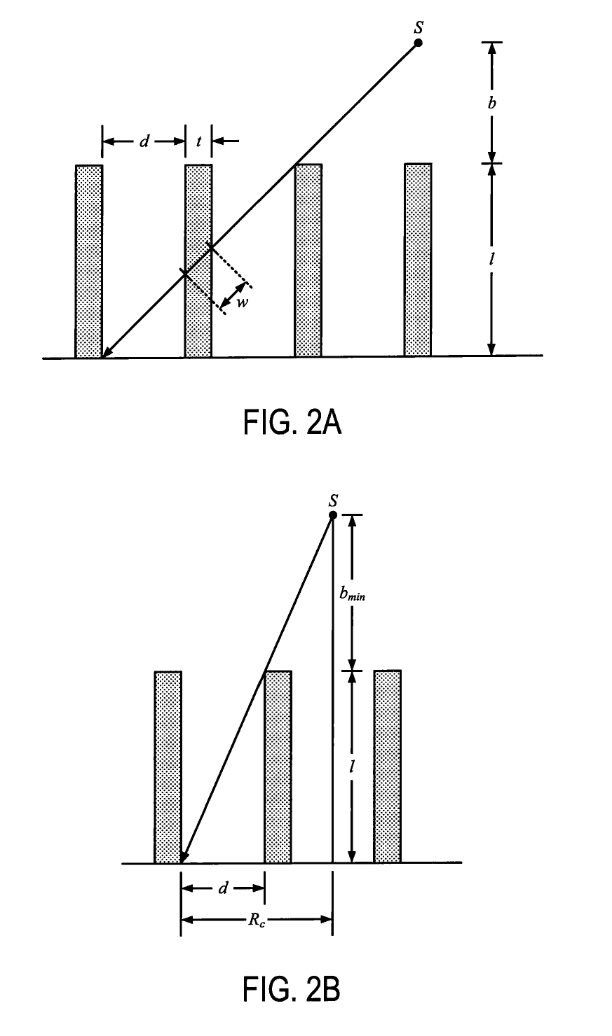

Consideration is now given to the optimization of a collimator design for use with, for example, the MBI system of FIG. 1. The performance of a collimator is characterized by its cross-sectional hole shape; hole dimensions, such as length and diameter; septal thickness; and collimator material. Two main measures of collimator performance, geometric efficiency and collimator resolution, are determined by these adjustable hole dimensions. Namely, these measures of performance are determined by channel length, l; hole diameter, or parallel-to-parallel side distance, d; and septal thickness, t. The dimensions are illustrated in the schematic representation of an exemplary parallel-hole collimator arrangement in FIG. 2A.

The geometric efficiency of a parallel-hole collimator is described by:

$$g = \frac{{A}_{hole}}{4 π {l}_{e}^{2}} \cdot \frac{{A}_{hole}}{{A}_{unit}} ; \qquad Eqn . ( 1 )$$

where Aₕₒₗₑ is the open area of the collimator channel aperture, or “hole”; Aᵤₙᵢₜ is the area of the lattice cell unit; and lₑ is the effective channel length, which can be expressed as lₑ=l−2μ⁻¹, where μ is the linear attenuation coefficient of the collimator material at the energy of interest, which is around 140 kiloelectron volts (“keV”) for photons produced by Tc-99m.

For a hexagonal hole shape matched to a hexagonal detector element, this can be revised as:

$$\begin{matrix}{A}_{hole} = \frac{\sqrt{3}}{2} \cdot {d}^{2} ; & Eqn . ( 2 ) \\ {A}_{unit} = \frac{\sqrt{3}}{2} \cdot {( d + t )}^{2} . & Eqn . ( 3 )\end{matrix}$$

Thus, the geometric efficiency for this hexagonal-hole collimator configuration is given by substituting Eqns. (2) and (3) into Eqn. (1), yielding the following relationship:

$${g}_{hex } = \frac{\sqrt{3}}{8 π {l}_{e}^{2}} \cdot \frac{{d}^{4}}{{( d + t )}^{2}} . \qquad Eqn . ( 4 )$$

Similarly, for a square hole shape matched to a square detector element shape, this can be revised as:

Aₕₒₗₑ=d² Eqn. (5); and

Aᵤₙᵢₜ=(d+t)² Eqn. (6).

Thus, the geometric efficiency for this square-hole collimator configuration is given by substituting Eqns. (5) and (6) into Eqn. (1), yielding the following relationship:

$${g}_{sq} = \frac{1}{4 π {l}_{e}^{2}} \cdot \frac{{d}^{4}}{{( d + t )}^{2}} . \qquad Eqn . ( 7 )$$

Geometric efficiency is a unitless quantity and, as such, in order to be more clinically relevant, it is often converted to sensitivity with units of counts per minute per microcurie (cpm/μCi) using the following equation:

S=2.2×10⁶ηg Eqn. (8);

where η is the number of gamma rays emitted per nuclear decay.

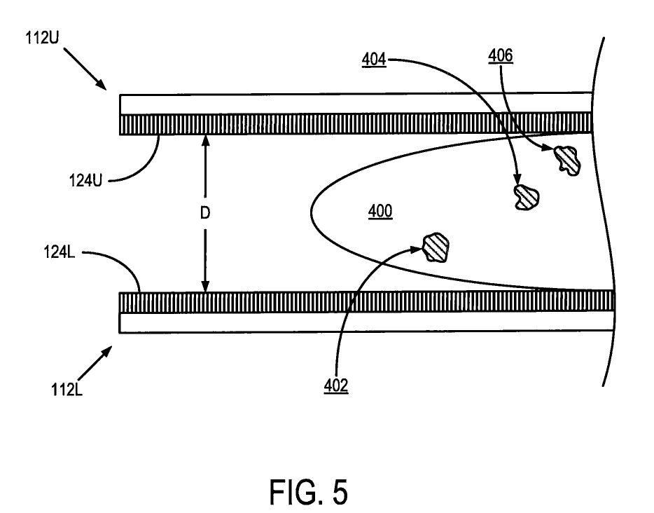

The resolution of a collimator, R_{c}, is determined by its hole dimensions and the distance of the radiation source from the collimator. Formally, represented as:

$${R}_{c} = \frac{d ( {l}_{e} + b )}{{l}_{e}} ; \qquad Eqn . ( 9 )$$

where b is the distance from the source to the collimator surface, as illustrated in FIG. 5A. For a conventional gamma camera, which utilizes a single scintillating crystal coupled to photomultiplier tubes, the collimator resolution combines with the intrinsic resolution of the detector to produce a system resolution that is worse than either resolution component. The system resolution of a conventional gamma camera, R_{S}, is defined as:

R_{S}=\sqrt{R_{c}²+R_{I}²} Eqn. (10);

where R_{I} is the intrinsic detector resolution.

At a desired resolution limit, collimator geometric efficiency can be maximized by expressing it as a function of channel length, g(l), and then setting the derivative, dg(l)/dl to zero. By way of example, this approach is performed using Eqns. (4) and (7) to find the channel length, l, that gives substantially maximum geometric efficiency for hexagonal-hole and square-hole collimators, respectively. Eqns. (4) and (7) can be expressed in terms of channel length, l, by substituting the respective equations into the expression for collimator resolution, Eqn. (9), and the following expression for septal thickness:

$$t = \frac{2 dw}{l - w} ; \qquad Eqn . ( 11 )$$

where w is the shortest path length for gamma rays to travel from one hole to another, as illustrated in FIG. 5A, and it is related to the septal penetration, β, by e^{-μw}≦β. These substitutions yield the following resolution-limited geometrical efficiencies for a hexagonal-hole collimator and for a square-hole collimator:

$$\begin{matrix}{g}_{hex} = \frac{\sqrt{3}}{8 π} \cdot \frac{{R}_{c}^{2}}{{( l - 2 {μ}^{- 1} + b )}^{2}} \cdot {( \frac{l μ + ln β}{l μ - ln β} )}^{2} ; and & Eqn . ( 12 ) \\ {g}_{sq} = \frac{1}{4 π} \cdot \frac{{R}_{c}^{2}}{{( l - 2 {μ}^{- 1} + b )}^{2}} \cdot {( \frac{l μ + ln β}{l μ - ln β} )}^{2} . & Eqn . ( 13 )\end{matrix}$$

The optimal channel length, lₒₚₜ, that gives the maximum geometric efficiency for a hexagonal-hole and square-hole collimator is found by setting the derivatives of Eqns. (12) and (13), respectively, to zero. For both Eqns. (12) and (13), this yields:

$${l}_{opt} = - \frac{ln β}{μ} \cdot \sqrt{2 \cdot {( \frac{ln β}{μ} )}^{2} + 4 \cdot \frac{ln β}{{μ}^{2}} - 2 b \cdot \frac{ln β}{μ}} . \qquad Eqn . ( 14 )$$

Using this optimal channel length, lₒₚₜ, the optimal hole diameter, dₒₚₜ, and optimal septal thickness, tₒₚₜ, can similarly be calculated as:

$$\begin{matrix}{d}_{opt} = {R}_{c} \cdot \frac{{l}_{opt} - 2 {μ}^{- 1}}{{l}_{opt} - 2 {μ}^{- 1} + b} ; and & Eqn . ( 15 ) \\ {t}_{opt} = - \frac{2 {d}_{opt} ln β}{{l}_{opt} μ + ln β} . & Eqn . ( 16 )\end{matrix}$$

Together, Eqns. (14)-(16) describe the hole dimensions of a generally optimized collimator. This general optimization, while useful for conventional gamma cameras, does not account for the effects of coupling a collimator to a so-called “pixelated” detector, in which the pixelated detector includes a plurality of detector elements that generally correspond to a single pixel in a resultant image. With pixelated detectors, a matched collimator design is possible in which each collimator hole directly aligns with each detector element.

In the case of a pixelated camera with a matched collimator, the detector elements are matched to the collimator holes so that each hole and its corresponding detector element are independent of other hole and detector element units. In this configuration, the system resolution is determined solely by the collimator resolution, offering improved spatial resolution over traditional hexagonal hole designs. The collimator resolution equation for a matched collimator with a pixelated detector is expressed slightly differently. In particular, a correction factor, ρ, is incorporated and the classic collimator resolution equation is adjusted as follows:

$${R}_{c} = ρ \cdot \frac{d ( l + b - {μ}^{- 1} )}{l - 2 {μ}^{- 1}} . \qquad Eqn . ( 17 )$$

The correction factor, ρ, accounts for several factors, such as hole shape, angular averaging, and the ratio of detector-to-source distance to channel length. For a source-to-collimator distance, b, of about 3 cm, the correction factor, ρ, has values of about 0.938 and about 0.867 for square and hexagonal hole collimators, respectively. Eqn. (17) is used to calculate the collimator resolution of matched collimators.

In addition to improved system resolution, another potential advantage of using a matched collimator with a pixelated system is that the small inactive portions at the edge of each detector element are covered by the collimator septa rather than being exposed in the area of the holes, so that increased geometric efficiency can be achieved. Also, the alignment of the septa with detector elements reduces possible aliasing patterns that can arise due to mismatch of hexagonal collimator holes and square detector elements.

In some configurations of a matched collimator design, the size of the collimator lattice unit, (d+t), equals the size of each detector element, or the pixel size, p; however, in other configurations the size of each detector element is matched to the aperture of the collimator channel. An iterative procedure is used to solve for the optimal hole dimensions described above with respect to Eqns. (14)-(16). For example, an iterative procedure is established that performs two tasks, generally. First, the possible combinations of hole dimensions are determined, then an evaluation is made as to which combinations of the determined hole dimensions have the best geometric efficiency or sensitivity.

Another constraint on the possible sets of hole dimensions relates to the septal penetration, w. Septal penetration can degrade the quality of an image by causing star-like patterns and loss of contrast. A collimator is substantially free of such penetration artifacts if it meets the University of Chicago penetration criterion:

$$P \leq μ l ( 1 - \frac{{A}_{hole}}{{A}_{unit}} ) ; \qquad Eqn . ( 18 )$$

where P is a penetration parameter that is dependent on hole pattern. For square collimator holes in a square array arrangement, P=P_{sq}=12.57±0.53, and Eqn. (18) becomes,

$${P}_{sq} \leq μ l ( 1 - {( \frac{d}{d + t} )}^{2} ) . \qquad Eqn . ( 19 )$$

By using the inequality in Eqn. (19) to determine the minimum and maximum values of l and d, it is assured that all sets of hole dimensions falling between these values will meet this constraint as well.

One condition in the collimator design is to ensure that the resultant collimator resolution, R_{c}, calculated for a set of hole dimensions is equal to or better than a desired threshold resolution. Exemplary threshold values of R_{c} are about 5.0 mm and about 7.5 mm. Because of the trade-off between sensitivity and resolution, the collimator resolution, R_{c}, is fixed and the geometric efficiency is calculated for that specific resolution, R_{c}.

Classical collimator theory assumes that the geometric efficiency is independent of source position and distance from the collimator face, as is evident in Eqn. (1); however, this assumption is invalid for a source very close to the collimator surface. More particularly, the collimator's field-of-view and the equations governing collimator performance only apply at distances beyond which a source can be detected in adjacent holes. This minimum distance is indicated as bₘᵢₙ in FIG. 5B. From the exemplary collimator setup, and its simple geometry, illustrated in FIG. 5B, the minimum source-to-collimator distance, bₘᵢₙ, can be calculated from,

$${b}_{m i n} = \frac{l}{2} + \frac{lt}{d} . \qquad Eqn . ( 20 )$$

For source-to-collimator distances less than bₘᵢₙ, the geometric efficiency and collimator resolution are highly dependent on source location relative to the collimator septa. If a source is directly over a single hole, the geometric efficiency will decrease as,

$$\frac{1}{{( b + l )}^{2} } ; \qquad Eqn . ( 21 )$$

and collimator resolution will be independent of distance and determined only by the hole diameter with no contribution from the channel length. On the other hand, for a source located directly over the septa, geometric efficiency may increase with distance whereas resolution may remain relatively unchanged.

With a matched collimator, the resolution of the MBI system 110, R_{S}, and the collimator, R_{c}, are equivalent; therefore, the MBI system 110 resolution, R_{S}, can be precisely determined by the collimator characteristics.

The desired collimator hole and channel dimensions are selected and constrained for the variable input parameters of linear attenuation coefficient, μ, which is related to the selected collimator material; source-to-collimator distance, b, which is effectively related to the average breast compression; detector element size, p; and desired collimator resolution, R_{c}. The geometric efficiency of the collimator is determined using these parameters and converted to a measure of collimator sensitivity to ensure than an adequate sensitivity is achieved. The design that maximizes sensitivity without exceeding the required collimator resolution, R_{c}, is identified and selected as the design to manufacture the collimator.

In general, two collimator design parameters are optimized. The first parameter is the optimum collimator channel length, lₒₚₜ, for a selected detector element size, p, that will yield a desired collimator resolution, R_{c}, such as 5.0 mm, for a given source-to-collimator distance, b, such as around 3.0-3.5 cm from the upper collimator surface. The second parameter is the optimum intrinsic detector element size for a detector that will maximize sensitivity while meeting the above requirements.

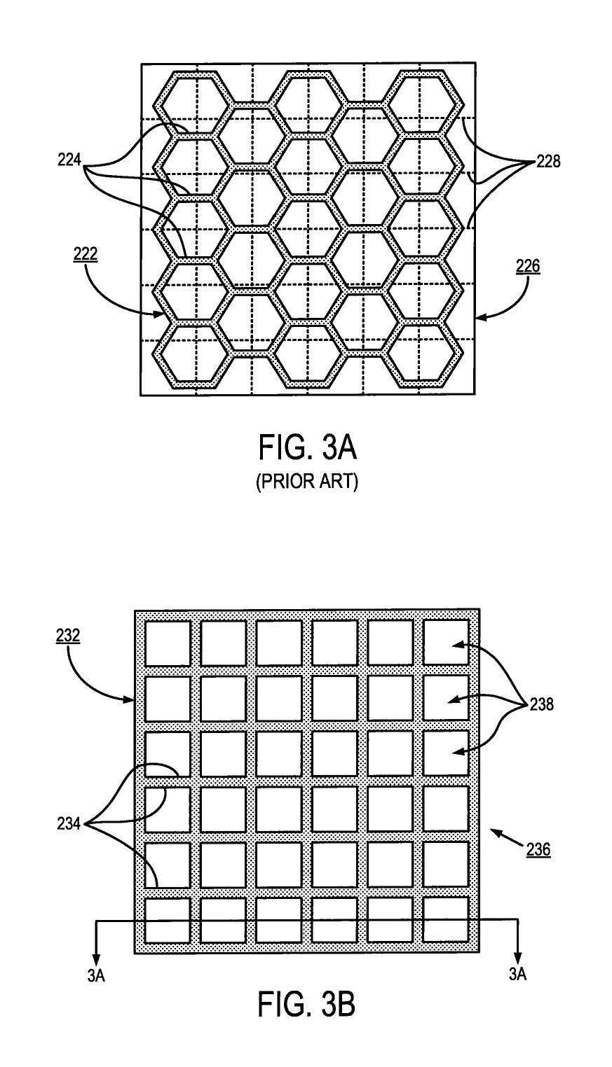

Traditionally, commercial small field-of-view gamma camera systems (such as those available from Dilon Technologies, Gamma Medica-Ideas, Digirad Corp.) have a collimation aperture, or hole, structure that does not match the structure of the pixelation in the detector. For example, and referring to FIG. 3A, existing small field-of-view gamma camera systems employ a hexagonal-hole collimator, such as those traditionally used in conventional gamma cameras that employ large sodium iodide crystals. This existing design employs a collimator 222 including hexagonally-shaped holes 224 overlaid on a detector 226 having square-shaped individual detector elements 228. In addition to this variation between collimator hole shape and detector element shape, the holes 224 of the collimator 222 are offset with respect to the detector elements 228 of the detector 226. These mismatches in shape and alignment are less than optimal for detectors having a square pixelated structure. This is because pixelated detectors will have reduced sensitivity and increased boundary effects at the borders between adjacent detector elements.

Referring now to FIG. 3B, the present invention provides a new collimator and detector design that strikes a balance between sensitivity, resolution, and noise in the resulting image by matching the cross-section collimator hole shape to the shape of the detector elements in the gamma camera. For example, a collimator 232 is provided that includes square holes 234. In addition, the holes 234 are sized to match a detector 236 having square detector elements 238. Thus, each hole 234 in the square-hole collimator 232 is aligned with a detector element 238. In this manner, the use of the detector element is increased resulting in better resolution and sensitivity. While, this matched hole and detector design is described with respect to square holes and detector elements, it is contemplated that the matching of cross-sectional collimator hole shape to pixelation structures of other arrayed detector elements may be desirable. For example, the matching of cross-sectional collimator hole shape to pixelation structures can employ circular patterns, triangular patterns, or combinations thereof, such as when regions of circular collimator holes match circular detector elements and regions of triangular collimator holes match with triangular detector elements.

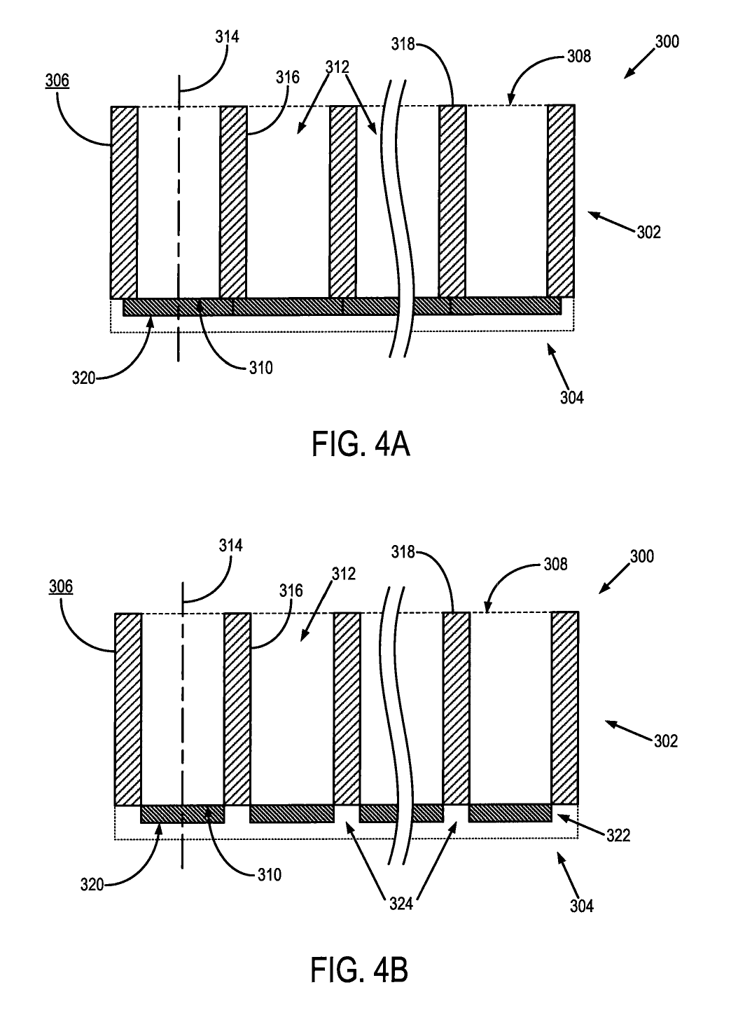

With reference now to FIG. 4A, an exemplary gamma camera 300, for example, the configuration illustrated in FIG. 3B as viewed along cross-section 4A, includes a collimator 302 and detector 304. The collimator 302 includes a collimator plate 306 that is composed of a radiation absorbing material. Exemplary radiation absorbing materials include lead, which has a linear attenuation coefficient, μ, of around 26.32 per centimeters (cm⁻¹) for photon energies at around 140 keV, and tungsten, which has a linear attenuation coefficient, μ, of around 34.48 cm⁻¹ for photon energies at around 140 keV. It will be appreciated by those skilled in the art, however, that the collimator plate 306 can similarly be composed of other radiation absorbing materials. The collimator plate 306 includes an upper surface 308 and a lower surface 310. A plurality of channels 312 are formed in the collimator plate 306 and extend along a longitudinal axis 314 from the upper surface 308 of the collimator plate 306 to the lower surface 310 of the collimator plate 306. The thickness of the collimator plate 306 corresponds, then, to the length of each of the channels 312. Each channel 312 includes an inner surface 316. For channels 312 having a circular cross-section shape, this inner surface 316 has only one edge; however, for channels 312 having, for example, a square cross-sectional shape, the inner surface 316 includes four edges. The opening formed by each channel 312 in the upper or lower surface of the collimator plate 306 is referred to as a “hole,” or an “aperture.” The portion of the collimator plate 306 disposed between an edge of the inner surface 314 of a channel 312 to an edge of the inner surface 314 of an adjacent channel 312, and along a straight line perpendicular to and connecting the longitudinal axes 314 of the respective channels 312, is generally referred to as a septum 318.

The detector 304 portion of the gamma camera 300 includes a plurality of detector elements 320 that are arranged in an arrayed pattern. For example, the detector elements 320 are arranged such that each detector element 320 is adjacent and in substantial contact with at least two other detector elements 320. Exemplary arrangements of this nature include a square array pattern, such as the one shown in FIGS. 3A and 3B. An adjacent array configuration of this type is employed to match each channel 312 in the collimator 300 with a corresponding detector element 320, such that the cross-sectional shape, but not the size, of the channel 312 and detector element 320 match. Such a configuration is beneficial when to align the detector elements 320 such that the small inactive portions at the edge of each detector element 320 are covered by the collimator septa 318 rather than being exposed in the area of the channel 312, so that a desired geometric efficiency can be achieved.

As shown in FIG. 4B, however, the detector elements 320 need not be in direct contact with each other. Instead, they may be arranged in a spaced arrayed pattern 332. Such a spaced array configuration includes a space 324 between detector elements 320 designed to match each channel 312 in the collimator 300 with a corresponding detector element 320, such that both the size and cross-sectional shape of the channel 312 and detector element 320 match.

While this matched collimator-detector element design is desirable to increase resolution and sensitivity, the actual resolution may degrade with distance from the upper surface 308 of the collimator 302. Thus, in practice, designing a collimator 302 with better resolution reduces its sensitivity. In particular, sensitivity degrades in proportion to the square of resolution; therefore, a twofold improvement in resolution yields a fourfold reduction in sensitivity. This reduced sensitivity may result in sub-optimal image quality due to low photon detection counts. In a gamma camera configuration with collimator channels, or holes, matched to detector elements, the size of the detector elements dictates the size of the channel hole size, and, therefore, the channel length and septal thickness are varied in order to adjust the tradeoff between resolution and sensitivity. In this manner, for a given collimator hole structure, the collimator channel length and septal thickness may be adjusted in order to achieve a desired resolution at a given depth.

The aforementioned collimator 302 can be employed in a dual-head pixelated gamma camera system, such as the one illustrated in FIG. 1. Using design constraints that will be described below in detail, the collimator yields high sensitivity, while still maintaining adequate resolution for the detection of small breast lesions by determining a combination of collimator characteristics that produce optimum results. As will be described below, it is contemplated that a user adjustable collimator system may be utilized. The gamma camera characteristics can also be varied based on the tissue being imaged, such as the thickness of the breast tissue being imaged. In a pixelated gamma camera system, such as the MBI system 110, the maximum distance that a tumor can be from the surface of a collimator is half the separation of the gamma cameras. The average compressed breast thickness in MBI applications is on the order of around 6 cm, while the typical range of compressed thickness is around 2.5-11.5 cm. With a dual-head MBI system, the maximum distance from a breast lesion to the collimator surface is half the total breast thickness; therefore, source-to-collimator distances of about 3 cm and about 6 cm are reliably selected as being representative of the average compressed mid-breast and total breast thicknesses, respectively.

By way of example, FIG. 5 illustrates a schematic diagram of three tumors (402, 404, and 406) in a breast 400 that is being imaged by a dual-head gamma camera system, such as the MBI system 110. While the first tumor 402 and the third tumor 406 are sufficiently close to respective gamma cameras (112L and 112U, respectively) so as to be readily discernable in the resulting image, the second tumor 404 is located in the center of the breast 400 and, therefore, is at the maximum distance from either collimator 124U and 124L. Therefore, the second tumor 404 may not be represented in the resultant image with a spatial resolution sufficient to be identifiable.

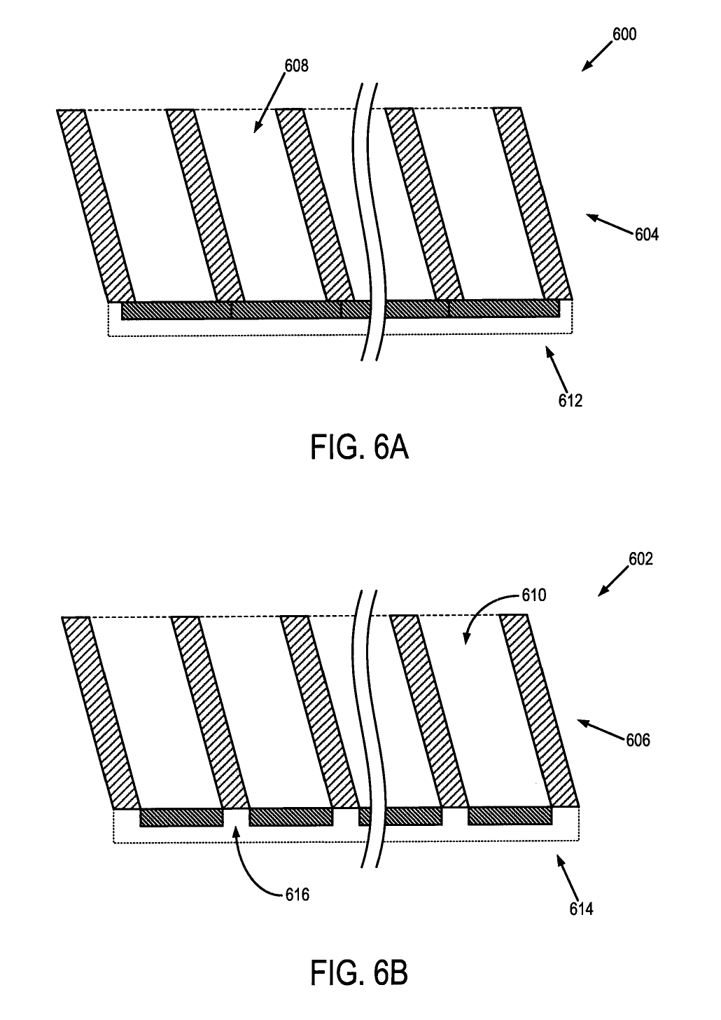

Turning now to FIGS. 6A and 6B, additional exemplary configurations 600, 602 of a gamma camera system employing a square aperture collimator shown in FIG. 3B is provided. In these configurations, collimators 604, 606 having slanted openings 608, 610 are used. Such designs are exemplary of some of the many design variations contemplated. These configurations 600, 602 may be advantageous, for example, in providing good coverage and even penetrating the chest wall. Similar to the systems described above with respect to FIGS. 4A and 4B, the configurations 600, 602 illustrated in FIGS. 6A and 6B vary based on the configuration of an associated detector 612, 614. That is, the detector 612 of FIG. 6A includes abutting pixels, whereas the detector 614 of FIG. 6B has a space 616 between pixels.

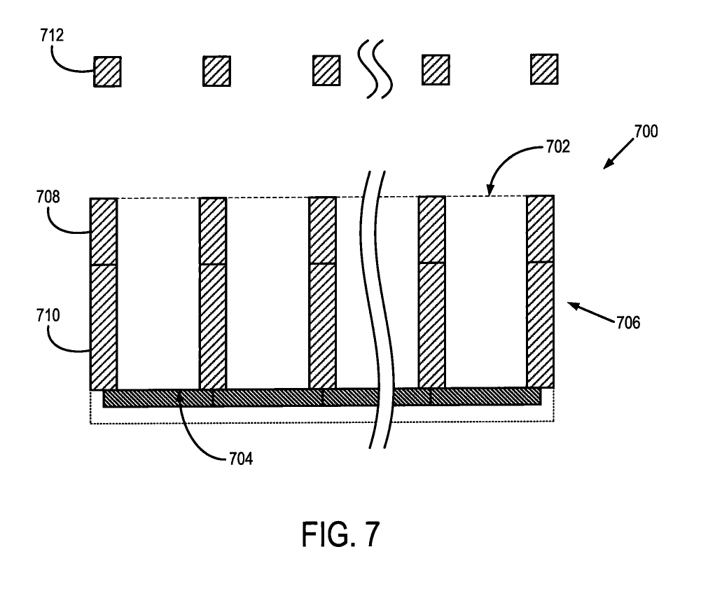

Referring now to FIG. 7, an adjustable collimator system 700 is illustrated. Specifically, the collimator system 700 has a variable height, such that the a distance between an upper surface 702 and a lower surface 704 of the collimator plate 706 can be selected by the user. Specifically, as described above, in general, two collimator design parameters can be optimized. The first parameter is the optimum collimator channel length, lₒₚₜ, for a selected detector element size, p, that will yield a desired collimator resolution, R_{c}, such as 5.0 mm, for a given source-to-collimator distance, b, such as around 3.0-3.5 cm from the upper collimator surface. The second parameter is the optimum intrinsic detector element size for a detector that will maximize sensitivity while meeting the above requirements. With respect to the former, by providing an adjustable collimator system 700 having a variable collimator channel length, lₒₚₜ, the collimator can be adjusted for specific source-to-collimator distances, b, which can vary due to compression characteristics. As illustrated in FIG. 7, this adjustable collimator system 700 can be achieved, for example, by providing a first collimator portion 708 and second collimator portion 710. The first collimator portion 708 and the second collimator portion 710 may, for example, be removably or stackable engaged and interchangeable with additional collimator portions so as to allow user adjustment of distance between an upper surface 702 and a lower surface 704 of the collimator plate 706, such as by replacing the first collimator portion 708 with a third collimator portion 712 having different characteristics. Additionally or alternatively, the first collimator portion 708 and the second collimator portion 710 may, for example, be slidable engaged such that one portion may slide over another to adjust the distance between an upper surface 702 and a lower surface 704 of the collimator plate 706.

Thus, the present invention provide for systems and methods for performing nuclear medicine-based imaging. A parallel-hole collimation scheme that is optimized for use with a dual-head gamma camera system is described. The collimation scheme uses pixelated detectors (such as Cadmium Zinc Telluride, multi-crystal Cesium Iodide or multi-crystal Sodium Iodide) where each pixel in a detector is matched geometrically to a hole in the collimator. Matching may include alignment of a collimation aperture to a pixel in a one aperture to one pixel ratio, although other ratios are also applicable. Matching the collimation hole size to the pixel dimensions can improve the sensitivity of the detector to radiation.

In one implementation, a nuclear medicine-based, high-resolution, breast imaging technology, such as molecular breast imaging (“MBI”), is used to image breast tissue. For example, co-pending Patent Application Serial No. WO/2008/073897, filed Dec. 10, 2007, entitled “System And Method For Quantitative Molecular Breast Imaging,” discloses systems, apparatus, and methods for performing quantitative tumor analysis using ultra high resolution detectors, and is herein incorporated by reference in its entirety.

The various steps or acts in a method or process may be performed in the order shown, or may be performed in another order. Additionally, one or more process or method steps may be omitted or one or more process or method steps may be added to the methods and processes. An additional step or action may be added in the beginning, end, or intervening existing elements of the methods and processes. Based on the disclosure and teachings provided herein, a person of ordinary skill in the art will appreciate other ways and/or methods for various implements.

The present invention has been described in terms of one or more preferred embodiments, and it should be appreciated that many equivalents, alternatives, variations, and modifications, aside from those expressly stated, are possible and within the scope of the invention.

1. A nuclear imaging system comprising:
at least two gamma cameras in spaced arrangement such that a region for receiving a portion of a subject is defined therebetween, each gamma camera including a detector comprising a plurality of detector elements arranged in an array;
a compression mechanism capable of moving at least one of the gamma cameras along an axis and configured to compress the portion of the subject to a selected thickness;
a processor configured to access a computer readable storage medium having stored thereon instructions that, when executed by the processor, cause the processor to utilize the at least two gamma cameras to detect photons emitted from the portion of the subject in the region between the at least two gamma cameras in order to create at least one imaging data set;
a collimator coupled to each of the at least two gamma cameras, the collimator comprising:
a collimator plate composed of a radiation absorbing material and having formed therein a plurality of channels spaced in an arrayed arrangement, each of the plurality of channels extending from an upper surface of the collimator plate to a lower surface of the collimator plate along a distance configured to substantially maximize a geometric efficiency of the collimator for a selected septal penetration, source-to-collimator distance, and collimator material;
a plurality of septa formed between each adjacent ones of the plurality of channels; and
wherein the plurality of detector elements and the plurality of channels have a substantially similar cross-sectional shape.

2. The nuclear imaging system of claim 1 wherein the radiation absorbing material of which the collimator is composed is at least one of lead and tungsten.

3. The nuclear imaging system of claim 1 wherein the distance of each of the plurality of channels extending between the upper surface of the collimator plate and the lower surface of the collimator plate is configured to substantially maximize a source-to-collimator distance that is substantially half a thickness of the portion of the subject under examination.

4. The nuclear imaging system of claim 1 wherein the collimator is a parallel collimator in which a longitudinal axis of each of the plurality of channels is substantially parallel to a longitudinal axis of each other of the plurality of channels, and the longitudinal axes of the plurality of channels are substantially perpendicular to both the upper and lower surfaces of the collimator plate.

5. The nuclear imaging system of claim 1 wherein the collimator is a slanted collimator in which a longitudinal axis of each of the plurality of channels is substantially parallel to a longitudinal axis of each other of the plurality of channels, and the longitudinal axes of the plurality of channels are not perpendicular to either the upper or lower surface of the collimator plate.

6. The nuclear imaging system of claim 1 wherein the collimator is configured to allow user selection of distance of each of the plurality of channels extending between the upper surface of the collimator plate and the lower surface of the collimator plate.

7. The nuclear imaging system of claim 6 wherein the collimator plate includes a first portion removably engaged with a second portion.

8. The nuclear imaging system of claim 7 wherein the first portion is configured to be disengaged from the second portion, wherein the second portion is configured receive a third portion, and wherein the first portion, second portion, and third portion, have differing dimension to allow user selection of the distance of each of the plurality of channels extending between the upper surface of the collimator plate and the lower surface of the collimator plate.

8. The nuclear imaging system of claim 6 wherein the collimator plate includes a first portion slidably engaged with a second portion.

9. A method of manufacturing a collimator system for use with a nuclear imaging system including at least two gamma cameras in spaced arrangement such that a region for receiving a portion of a subject is defined therebetween, each gamma camera including a detector comprising a plurality of detector elements arranged in an array, a compression mechanism capable of moving at least one of the gamma cameras along an axis and configured to compress the portion of the subject to a selected thickness, and a processor configured to access a computer readable storage medium having stored thereon instructions that, when executed by the processor, cause the processor to utilize the at least two gamma cameras to detect photons emitted from the portion of the subject in the region between the at least two gamma cameras in order to create at least one imaging data set, the method comprising:
forming a collimator plate composed of a radiation absorbing material;
creating a plurality of channels spaced in an arrayed arrangement; and
forming upper surface of the collimator plate and a lower surface of the collimator plate, the upper surface of the collimator plate and the lower surface of the collimator plate separated by a distance calculated using a relationship of geometric efficiency of the collimator to source-to-collimator distance.

10. The method of claim 9 wherein the plurality of channels are created to have a substantially similar cross-sectional shape to the plurality of detector elements.

11. The method of claim 9 wherein a resolution of the collimator is substantially matched to a resolution of the detector.

12. The method of claim 11 wherein the resolution of the collimator is calculated using a correction factor accounting for at least one of hole shape, angular averaging, and a ratio of detector-to-source distance to channel length.

13. The method of claim 11 wherein the resolution of the collimator is calculated according to:
$${R}_{c} = ρ \cdot \frac{d ( l + b - {μ}^{- 1} )}{l - 2 {μ}^{- 1}} ;$$
where R_{c} is the collimator resolution, ρ is a correction factor, d is the distance between the upper surface of the collimator plate and the lower surface of the collimator plate, b is the source-to-collimator distance, and μ is a linear attenuation coefficient of the collimator material at an energy of interest.

14. The method of claim 9 further comprising forming the collimator plate from a plurality of removably engageable portions.
